(19) United States
(12) Patent Application Publication
(10) Pub. No.: US 2025/0071520 A1
(43) Pub. Date: Feb. 27, 2025

(54) INDOOR TRACKING SYSTEM AND METHOD

(71) Applicant: BearCom Group, Inc., Garland, TX (US)

(72) Inventor: Michael Butler, Arlington, TX (US)

(21) Appl. No.: 18/811,014

(22) Filed: Aug. 21, 2024

Related U.S. Application Data
(60) Provisional application No. 63/534,291, filed on Aug. 23, 2023.

(51) Int. Cl. H04W 4/029; G08B 7/06; H04W 4/33

(52) U.S. Cl. CPC H04W 4/029; G08B 7/06; H04W 4/33

(57) ABSTRACT

A tracking system for determining the location of a tracking badge within a structure. The tracking system includes a plurality of beacons each configured to transmit a beacon identification signal with a beacon identifier, and a first tracking device that includes a button. The first tracking device is configured to receive one or more of the beacon identifiers. The first tracking device is configured to determine the beacon of the plurality of beacons that is closest in proximity to the first tracking device when the button is activated. The system includes a first gateway configured to receive from the first tracking device the beacon identifier of the closest proximity beacon, and a positioning engine that includes location information including a location of each of the plurality of beacons. The positioning engine is configured to identify a location of the closest proximity beacon. A computing system is configured to receive the location of the closest proximity beacon and transmit an alert to a plurality of transceivers.

### CROSS-REFERENCE TO RELATED APPLICATIONS

This application claims the benefit of U.S. Provisional Application No. 63/534,291, filed on Aug. 23, 2023, which is incorporated by reference herein in its entirety.

### FIELD OF THE INVENTION

The present invention relates generally to an indoor tracking system and related methods.

### BACKGROUND OF THE INVENTION

Indoor tracking systems exist but have limited functionality to provide end-to-end communication of location and emergency events, among other functions, particularly to on-site emergency or security personnel using two-way radios. The present invention provides a tracking system and method for identification of a location during an emergency or other situation.

The background description disclosed anywhere in this patent application includes information that may be useful in understanding the present invention. It is not an admission that any of the information provided herein is prior art or relevant to the presently claimed invention, or that any publication specifically or implicitly referenced is prior art.

### SUMMARY OF THE PREFERRED EMBODIMENTS

In accordance with a first aspect of the present invention, there is provided a method of tracking within a structure that includes a plurality of rooms including at least first and second rooms. The method includes providing at least first and second beacons, where the first beacon is disposed in the first room and the second beacon is disposed in the second room. The first beacon transmits a first beacon identification signal that includes a first beacon identifier and the second beacon transmits a second beacon identification signal that includes a second beacon identifier. The method includes providing at least a first tracking device that includes an activation member or button associated therewith, where the first tracking device is configured to receive the first beacon identification signal and the second beacon identification signal. When the activation member or button on the first tracking device is activated or pressed, the first tracking device is configured to determine whether the first beacon or second beacon is closer in proximity to the first tracking device, thereby determining a closest proximity beacon. The method includes transmitting, by the first tracking device, the beacon identifier of the closest proximity beacon to a gateway, and transmitting, by the gateway, the beacon identifier of the closest proximity beacon to a cloud service that includes a positioning engine. The positioning engine includes a map of the structure that associates the first beacon with the first room and the second beacon with the second room. The method includes determining, by the positioning engine, a location of the closest proximity beacon, transmitting, by the cloud service, the location of the closest proximity beacon to a computing system associated with the structure (possibly back through the gateway and to the computing system), and providing, by the computing system (and possibly through a base station), an alert to at least a first transceiver that identifies the location of the closest proximity beacon. The alert is at least one of an audio message, an audiovisual message or a visual message. A visual message may be, for example, a video, an image or the like.

The alert may be an audio message. The audio message may be routed through a base station and to a plurality of transceivers. The alert may be provided via text to speech. Determining whether the first beacon or second beacon is closer in proximity to the first tracking device may include determining which of the first beacon identification signal or second beacon identification signal is stronger or a stronger signal. The cloud service may be located offsite from the structure. The cloud service may be any system, way, method, archive, database or the like for including the positioning engine and storing the map or location data discussed herein. The first transceiver may be a two-way radio.

The gateway may be a first gateway located on a first floor of the structure and the structure may include a second floor with a second gateway. A first room button or activation member may be located in the first room. The first room button may be configured to transmit a first room identification signal that includes a first room identifier. When the first room button is pressed, the method includes the steps of transmitting to the computing system, by the first room button, the first room identifier, and providing to at least the first transceiver, by the computing system, a second alert that identifies the first room.

In accordance with another aspect of the present invention there is provided an indoor tracking system for determining the location of at least a first tracking badge within a structure that includes a plurality of rooms. The indoor tracking system includes a plurality of beacons each configured to transmit a beacon identification signal that includes a beacon identifier, and at least a first tracking device that includes an activation member or button associated therewith. The first tracking device is configured to receive one or more of the beacon identifiers. The first tracking device is configured to determine the beacon of the plurality of beacons that is closest in proximity to the first tracking device, thereby determining a closest proximity beacon. The system includes at least a first gateway configured to receive from the first tracking device the beacon identifier of the closest proximity beacon, and a positioning engine that includes location information comprising a location of each of the plurality of beacons. The positioning engine is configured to identify a location of the closest proximity beacon. The system includes a computing system, associated with the structure, configured to receive the location of the closest proximity beacon, and at least a first transceiver configured to receive and transmit an alert that identifies the location of the closest proximity beacon provided by the computing system. The positioning engine preferably includes a map or floorplan of the structure that associates each of the plurality of beacons with a different room within the structure.

The present invention provides the ability for a user to press a button or the like on a tracking badge to provide an alert that there is an emergency. For example, a worker in a factory may provide an alert that there is a fire, an active shooter, intruder, a medical emergency or some other issue. The tracking badge may include more than one button, icon, etc. that can be pressed, contacted or otherwise used (this may be referred to as input or activation herein) to provide alerts of different emergencies or events. The terms button nor activation member are not intended to be limiting and may include any activation member, button, icon, surface or the like that, when contacted, pressed or otherwise activated by a user in the event of an emergency or other button pressing event causes the actions discussed herein (e.g., the identification of the closest beacon) to take place. The “button” or activation member may not be a physical component. For example, the system may be implemented where a user audibly indicates that an event has occurred that requires security personnel and causes the system to identify the closest beacon. Therefore, pressing or activating a button may include this scenario (e.g., the user stating “alexa, alert security). The activation of the tracking device or badge, e.g., via the button or activation member may help the connect response (e.g., fire, police, building or onsite security personnel, medical personnel, etc.). Through the communication protocol(s) discussed herein, the system provides to the responding personnel the position of the tracking badge within a specific area or room within the building or structure. It will be appreciated that the term “room” used herein is not intended to be limiting and may not be a specific room with the building or structure, but may be a predetermined or specified area within the building or structure. For example, in a large warehouse, specific areas within a large or open area may be designated as “rooms” and each include its own beacon. In other words, within the context of this disclosure, a “room” does not need to have walls to divide each room from other rooms, but may be divided up into specific areas or volumes.

Preferably, the tracking badge includes low power requirements and thus many of the calculations regarding the location of the tracking badge are performed separately from the tracking badge. The tracking badge may merely send a data signal and at least a portion of the remainder of the processing or calculations may be done offsite (e.g., via the cloud service or other offsite data location) or in combination with an onsite computing system. As a result, the system includes low power badges that can be worn by users and that last a long time. All positioning determinations or calculations, etc. can be done offsite, on the cloud or the like.

### BRIEF DESCRIPTION OF THE DRAWINGS

The invention may be more readily understood by referring to the accompanying drawings in which:

FIG. 1 is a schematic plan view of a building or structure that includes a plurality of the components of the indoor tracking system in accordance with a preferred embodiment of the present invention; and

FIG. 2 is an exemplary flow chart of the system and method of indoor tracking in accordance with a preferred embodiment of the present invention.

Like numerals refer to like parts throughout the several views of the drawings.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments. If a component is not shown in a drawing then this provides support for a negative limitation in the claims stating that that component is “not” present. However, the above statement is not limiting and in another embodiment, the missing component can be included in a claimed embodiment.

Reference in this specification to “one embodiment,” “an embodiment,” “a preferred embodiment” or any other phrase mentioning the word “embodiment” means that a particular feature, structure, or characteristic described in connection with the embodiment is included in at least one embodiment of the-disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional. Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

In a preferred embodiment of the present invention, functionality is implemented as software executing on a server that is in connection, via a network, with other portions of the system, including databases and external services. The server comprises a computer device capable of receiving input commands, processing data, and outputting the results for the user. Preferably, the server consists of RAM (memory), hard disk, network, central processing unit (CPU). It will be understood and appreciated by those of skill in the art that the server could be replaced with, or augmented by, any number of other computer device types or processing units, including but not limited to a desktop computer, laptop computer, mobile or tablet device, or the like. Similarly, the hard disk could be replaced with any number of computer storage devices, including flash drives, removable media storage devices (CDs, DVDs, etc.), or the like.

The network can consist of any network type, including but not limited to a local area network (LAN), wide area network (WAN), and/or the internet. The server can consist of any computing device or combination thereof, including but not limited to the computing devices described herein, such as a desktop computer, laptop computer, mobile or tablet device, as well as storage devices that may be connected to the network, such as hard drives, flash drives, removable media storage devices, or the like.

The storage devices (e.g., hard disk, another server, a NAS, or other devices known to persons of ordinary skill in the art), are intended to be nonvolatile, computer readable storage media to provide storage of computer-executable instructions, data structures, program modules, and other data for the mobile app, which are executed by CPU/processor (or the corresponding processor of such other components). The various components of the present invention, are stored or recorded on a hard disk or other like storage devices described above, which may be accessed and utilized by a web browser, mobile app, the server (over the network), or any of the peripheral devices described herein. One or more of the modules or steps of the present invention also may be stored or recorded on the server, and transmitted over the network, to be accessed and utilized by a web browser, a mobile app, or any other computing device that may be connected to one or more of the web browser, mobile app, the network, and/or the server.

References to a “database” or to “database table” are intended to encompass any system for storing data and any data structures therein, including relational database management systems and any tables therein, non-relational database management systems, document-oriented databases, NoSQL databases, or any other system for storing data.

Software and web or internet implementations of the present invention could be accomplished with standard programming techniques with logic to accomplish the various steps of the present invention described herein. It should also be noted that the terms “component,” “module,” or “step,” as may be used herein, are intended to encompass implementations using one or more lines of software code, macro instructions, hardware implementations, and/or equipment for receiving manual inputs, as will be well understood and appreciated by those of ordinary skill in the art. Such software code, modules, or elements may be implemented with any programming or scripting language such as C, C++, C#, Java, Cobol, assembler, PERL, Python, PHP, or the like, or macros using Excel or other similar or related applications with various algorithms being implemented with any combination of data structures, objects, processes, routines or other programming elements.

The system and method described herein involves an indoor tracking system providing real-time or near-real-time communication of tracking, location, and emergency events to on-site or remote security. In an exemplary embodiment, at least a portion of or some of the components of the indoor tracking system may utilize LoRA, a physical proprietary radio communication technique based on spread spectrum modulation techniques derived from chirp spread spectrum technology, as a communication protocol. The system 50 in an embodiment preferably includes one or more of the following: a tracking badge or device 12 (that may be located on a person or object), one or more beacons 10 (that is or are each located or disposed within a room or predetermined area), one or more gateways 14, a cloud service 22, a positioning engine 24, an on-site special-purpose computing system 16, a base station 18, and one or more transceivers or two-way radios 20. It will be appreciated that the system includes getting information from the tracking badge 12 communicated through the gateway 14 to the cloud service 22, which utilizes the positioning engine 24 to calculate, identify or determine where in the room (or predetermined area) the tracking badge 12 is located based on the tracking badge's communication with the one or more beacons 10 (and, in particular, the closest beacon).

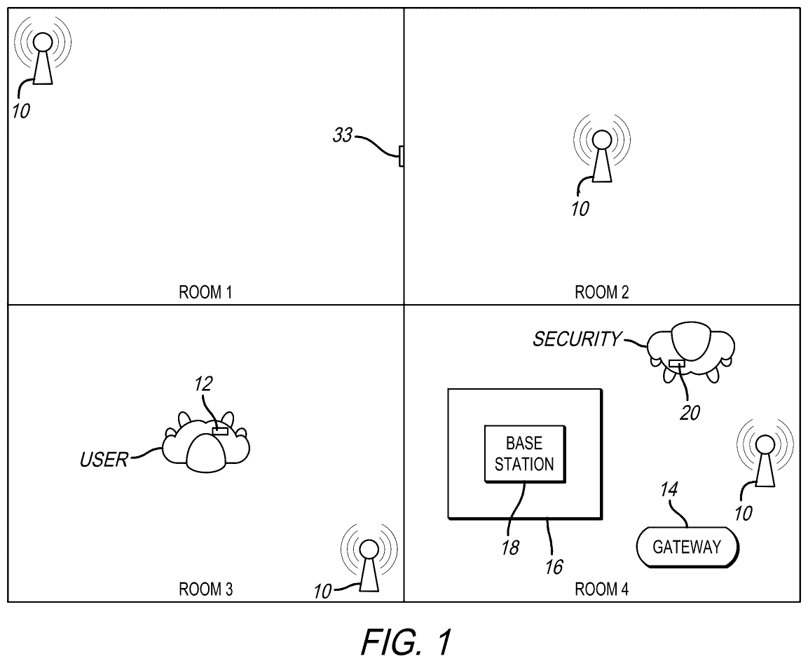

FIG. 1 shows an exemplary building 100 with four rooms with a plurality of the components of the inventive system that are discussed herein disposed throughout. As shown, the structure or building 100 includes a beacon 10 in each room, a user 102 wearing a tracking badge or device 12 (located in room 3), a gateway 14, computing system 16, base station 18 (all located in room 4), and a security person 104 (located in room 4) with a two-way radio 20.

In a preferred embodiment, the tracking badge 12 is a wearable device configured to transmit and receive data or information from a beacon 10 and/or to a gateway 14. For example, the tracking badge may be an Abeeway smart badge from Actility (see FIG. 1 from the priority provisional application—U.S. Provisional Application No. 63/534,291 and the text thereof, which is incorporated herein by reference in its entirety). The Abeeway smart badge is a multi-mode tracker combining GPS, Low Power-GPS (LP-GPS), Wi-Fi, LoRaWAN® and BLE radios with embedded sensors to support accurate indoor geolocation. The tracking badge 12 is configured to recognize beacons 10 (e.g., anchors) within a maximum range. It will be appreciated that the tracking badge 12 may recognize or sense more than one beacon 10 at a time. If a tracking badge 12 senses more than one beacon signal, the badge 12 may rank the signals based on signal strength, thus understanding that the strongest signal comes from the closest beacon 10. For example, the badge may take an RSSI (the signal level) and rank the beacon IDs based on signal strength. This ranking happens continuously as the user with the badge moves through the building. The badge may rank up to ten signals from ten beacons. Therefore, when the button is pushed, the tracking badge understands or identifies the closest beacon and relays that beacon's ID (or beacon identifier) to the gateway and beyond.

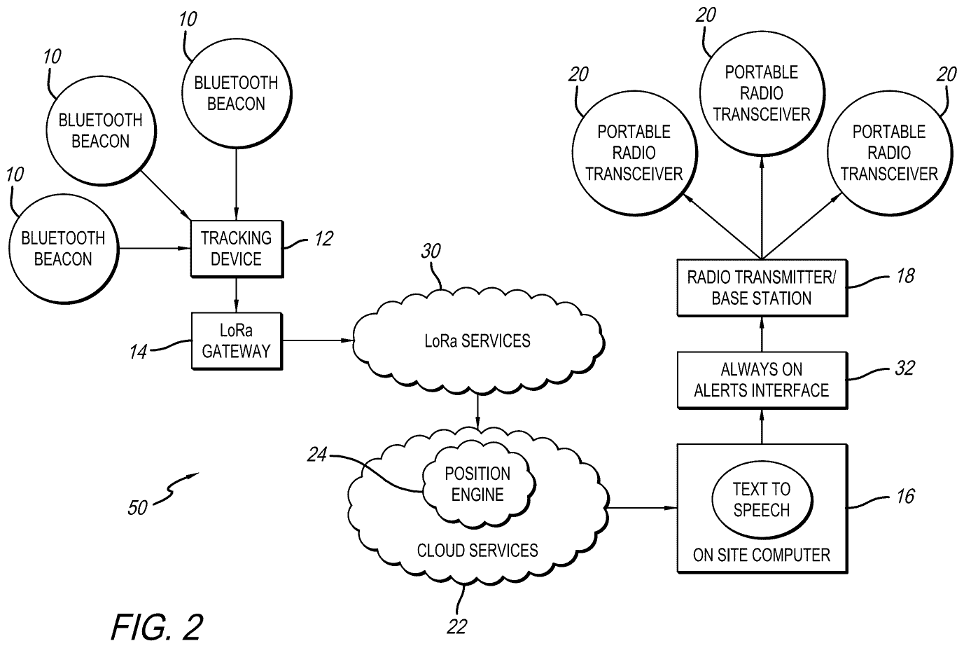

The beacons 10 preferably are stationary electronic devices configured to continually and/or periodically broadcast or transmit an ID or beacon identification signal that includes a beacon identifier. The tracking badge 12, as described above, is configured to recognize the broadcast messages or beacon identification signal from the beacon 10 when the tracking badge 12 is located within a maximum predetermined range from the beacon 10. For example, the beacon may be a Minew i10 indoor location beacon configured to broadcast ID messages via Bluetooth LE 5.0 (see FIG. 2 from the priority provisional application—U.S. Provisional Application No. 63/534,291 and the text thereof, which is incorporated herein by reference in its entirety). Other suitable beacons are within the scope of the present invention.

The gateway 14 preferably is an electronic communication device coupled to the on-site special-purpose computing system 16 (e.g., a laptop) and configured to operate with the base station 18. The building, structure or location may include more than one gateway. For example, in a multi-story building, each floor may have a gateway. For example, the gateway may be a LoRaWAN gateway from The Things Network, The Things Indoor Gateway, or other suitable gateway (see FIG. 3 from the priority provisional application—U.S. Provisional Application No. 63/534,291 and the text thereof, which is incorporated herein by reference in its entirety). Preferably, the gateway 14 and base station 18 are configured to implement an AlwaysOn system or network, which is a mobile land based radio system and which provides communication services to the two-way radio(s) 20. See, for example, U.S. Patent Publication Nos. 2020/0394897, 2022/0022008, 2022/0060563 and 2023/0412722 the entireties of which are incorporated by reference herein, for more information regarding the AlwaysOn system or network. The gateway 14 comprises a radio capable of transmission/reception of data with the tracking badge 12. In an embodiment, the gateway 14 communicates with the tracking badge using LoRa/WAN, as described herein. The radio or gateway 14 is also configured to communicate via internet protocol (e.g., TCP/IP) with an IoT (internet-of-things) network, such as The Things Network, also configured to operate via LoRa/WAN. One of ordinary skill in the art would understand that The Things Network is an IoT ecosystem comprising networks and devices using LoRaWAN.

The cloud service may be, for example, facilitated through The Things Network (e.g., The Things Stack Cloud) or other suitable ecosystem (see FIG. 4 from the priority provisional application—U.S. Provisional Application No. 63/534,291 and the text thereof, which is incorporated herein by reference in its entirety). For example, the cloud service is configured to provide web services via the internet for, among other things, facilitating connectivity between devices and gateways, and provide access to cloud-based applications. In an embodiment, the cloud service is an on-premises computing system in scenarios where it is desirable to keep data confidential on-site rather than providing the information to a cloud service. For example, certain contracts or customers may require that the data and processing provided by the cloud service be implemented on-site.

The positioning engine preferably is a web-based service positioning engine configured to receive location and map data and provide a plot map, location within a specified room, in accordance with the location and map data, and alerts such as emergency or dedicated buttons (that may be wireless) pressed within a specified room, among other features. If a dedicated button 33 (see FIG. 1) that is permanently located within a room is pressed, the data is not routed through the positioning engine, but goes straight to the computing system for generation of speech audio to be routed to and transmitted by the radios. The positioning engine is not needed because the computing system already knows in which room or predetermined location the button is located. This may be, for example, a panic button located at the front desk at a hotel or in a school classroom. Alissa's law, which is law in seven U.S. states, states that there must be a wireless panic button in every classroom within a school.

The map data preferably includes a map of the building or buildings (e.g., campus, warehouse or other structure) and may include dimension data so that a specific location can be pinpointed when the tracking badge is pressed or indicated. This data may be provided by the system user or installer, building manufacturer, constructor or the like. The location data may include information identifying the location of each of the plurality of beacons with the rooms of the structure. For example, the first beacon may be in room one, the second beacon in room two, the third beacon in room three and so on. After identification of the proper room within which the closest proximity beacond is located, the positioning engine provides the location data to the on-site special-purpose computing system. For example, the positioning engine may also be configured to provide audio and visual data for reproduction on systems connected to the computing system, such as through the base station/gateway to the two-way radio. The positioning engine in a preferred embodiment may be, for example, an IoT service provided by Norada (see FIG. 5 from the priority provisional application—U.S. Provisional Application No. 63/534,291 and the text thereof, which is incorporated herein by reference in its entirety). Other suitable positioning engines may be used instead of Norada's backend services.

The on-site special-purpose computing system is configured to operate with the gateway and base station to facilitate operation of an AlwaysOn network configured to provide communication capabilities with the two-way radio. The computing system preferably includes software applications configured to connect and set up the AlwaysOn network, and is configured to receive data from the positioning engine to be routed and displayed and/or spoken on the two-way radio.

The base station preferably is one or more electronic hardware devices configured to connect internet traffic from the computing system to the transceivers or two-way radios in a radio network. For example, the base station may be a MOTOTRBO trunking system using one or more repeaters to transmit and receive voice and data to/from one or more two-way radios (see FIG. 6 from the priority provisional application—U.S. Provisional Application No. 63/534,291 and the text thereof, which is incorporated herein by reference in its entirety). The two-way radio preferably may be, for example, a MOTOTRBO two-way radio configured to transmit and receive audio and visual data to/from a base station/repeater network (see FIG. 7 from the priority provisional application—U.S. Provisional Application No. 63/534,291 and the text thereof, which is incorporated herein by reference in its entirety). Other configurations of base station/gateway/repeaters are within the scope of the present invention. The base station and/or gateway preferably is configured to operate in connection with the AlwaysOn network.

FIG. 2 shows an exemplary flow chart of the system 50 and includes at least some of the components discussed above. In FIG. 2, the gateway 14 is a LoRa gateway and includes communication through LoRa Services 30 and then to the cloud service 22. As will be appreciated by those of skill in the art, LoRa is short for long range and is a wireless technology that uses spread spectrum modulation to create long-range communication links. FIG. 2 also shows the computing system 16 or onsite computer sending the text to speech alert or notification through the AlwaysOn alerts interface 32, which is connected to or part of the base station/radio transmitter 18 that send out the speech or audible alert to the various portable radio transceivers or two way radios 20. The AlwaysOn alerts interface 32 allows transmission of an alert from the computer to the radios (via the base station).

A process of indoor tracking is provided. In a preferred embodiment, at step 1, one or more beacons continuously or periodically each broadcasts its ID in a predefined space, such as a room in a building. At step 2, a tracking badge (e.g., worn by a person) receives the broadcast message from the beacon (of the ID) and when the button on the tracking badge is pushed or otherwise activated, the badge transmits the ID information of the at least one sensed beacon (the closest proximity beacon) to a gateway. At step 3, the gateway transmits, via TCP/IP or other suitable protocol, the data to a cloud service, such as The Things Stack Cloud. Step 3 is essentially getting the data offsite. However, this is not a limitation and the cloud service or other storage system may be located onsite. At step 4, the Things Stack Cloud or other cloud service routes the data to a positioning engine that is part of the cloud service. At step 5, the positioning engine identifies the badge location (based on the closest beacon) on a map using the location or beacon ID data and generates tracking or location data (i.e., identifies the location of the badge, based on the location of the closest proximity beacon, within the map or building). Previously, the blueprint map, floorplan or the like has been provided to the positioning engine and scaled relative to the beacon so that when the positioning engine receives the location data it can generate tracking or data and locate the user and badge within the predefined space (e.g., the room in the building). The positioning engine map data includes the location of each of the beacons and also may include the location of each of the one or more gateways. At step 6, the positioning engine provides the tracking data via TCP/IP protocol, or the like, to the computing system (back onsite). The computing system generates an audio alert that is relayed via the base station to the two-way radio(s) (e.g., the radios are in the possession of security personnel). The audio alert or message may be analog audio generated by the computing system that is transmitted to the radios, as if a person was speaking into a microphone (e.g., via text to speech technology). At step 7, the two-way radio displays (video/visual) and/or plays (audio) the audio alert, as appropriate. For example, the two-way radio plays an audio message alerting security to the location of a tracking badge within a room of a building. The transceiver may also be a mobile phone that may display and/or play the audio, visual or audiovisual message or alert. In other examples, the two-way radio provides a display of the map and location of the tracking badge, or alerts the security with an emergency notification and/or security breach notification. The alert may take the form of an alarm button that lights up or a buzzer or other notification on the two-way radio. In another embodiment, the alert may be a .wav or other audio file.

In a use-case, therefore, a user in a room of a building pushes the panic button on their tracking badge, and virtually instantaneously, all two-way radios connected to the network or computing system (e.g., the AlwaysOn network) play audio in which the two-way radios connected to the network relay an audio message to all security personnel in the building. The audio message may state “Alert. Emergency in Room 212” or the like.

In another embodiment, the tracking badge (or equivalent) is stationary, but the beacon is movable. In that scenario, the tracking badge is still configured to transmit and receive data to/from the gateway.

As an example, to set up the system, the following devices or services may be provided, ordered or obtained: order tracking badges, Enterprise Services, Anchors (beacons), Gateways, Norada backend service (e.g., positioning engine services), radios (e.g., two-way radios to match customer Land Mobile Radio (LMR) system, test laptop for staging and installation. In addition, customer blueprints for coverage area should be gathered, which will define the service area for the indoor tracking system.

For staging preparation, the following steps may be implemented: (1) download an SSH application such as PuTTY to the testing laptop; (2) download file transfer program such as WinSCP to the testing laptop; (3) configure the testing laptop for network capabilities; (4) plug in and charge location/panic tracking badges; (5) compile and build AlwaysOnAlerts interface device for voice radio system, including audio interfaces and Motorola accessory connector for the voice radio base station; (6) access Actility website and account with testing laptop.

In addition, the gateways must be commissioned, preferably by implementing the following steps: (1) log on and setup for an SSH session using the testing laptop; (2) setting the first parameters in the base station for allowing SSW access via a network connection; (3) SSH communications into the gateways; (4) upload Actility firmware configured to operate with the particular base station; (5) transfer firmware files to target directory in the base station using WinSCP (or the like) using a root-enable account on the base stations' operating system; (6) rename the files to fit the base station requirements; (7) reboot the base station; (8); after reboot, start SSH session using new IP address; (9) SSH into the gateway on new IP address so that the gateway is configured for DHCP IP addressing; (10) connect test laptop to the same network as the base station; and (11) log onto the base station using the testing laptop.

For support: (1) use Actility support password using SUPLOG menu to access; (2) obtain Long Range Relay (LRR) UIDD number; (3) copy LRR-UUID to text file; (4) generate new Public Key Text File using the SUPLOG menu; (5) copy LRR-UUID and public key txt to a text file; and (6) copy the Public Key Text from the base station to a text file on the test laptop. Then: (1) access the Actility site and go to the Create a Base Station section; (2) select the proper vendor from the list; (3) Paste the LRR_UUID into the form; (4) Select the proper RF (Radio Frequency) region; (5) Paste the Public Key into the Security Settings; (6) Set your Base Station Location; (7) Click on CREATE; (8) verify gateway on Actility Enterprise; and (9) repeat for each base station.

Subsequently, connections from the Actility Enterprise Site must be set up to the other software packages. Preferably, a Norada TTS MQTT broker connection is set up based on information received from Norada, an IPX connection to Abeeway Device Manager is set up (see Actuality web site for details), and a Bearcom MQTT broker is set up (see BearCom Innovation Lab for details).

On the Actility Enterprise site, preferably the tracking badges are added to Actility Enterprise Devices section, with each badge having three numbers documented with the packaging and in the form of vendor information. To do so, join EUI/APP EUI and obtain the APP Key and DevEUI, which will be needed for each device. On the Actility Enterprise Site, (1) access the Create a Device section, (2) select proper vendor from the list, (3) select the proper device model from the drop-down menu, (4) add a new device, with the following information: Device Name, DevEUI, Activation Mode OTAA, Join EUI/APP EUI, and APP Key, (5) turn on the tracking badge and verify that it joins the network by watching Last uplink station on the Actility web site, and (6) repeat for each device in the system.

Preferably, the Bluetooth beacon performance is optimized. First, download the proper configuration software and set the slot timing to optimize the beacon transmission timing for the devices Bluetooth anchor scan.

Preferably, Norada is also setup, as follows: (1) upload the customers blueprints to the Norada solve360 site for the project; (2) upload at least 4 beacons (BT anchors) to test spots on the blueprints; (3) physically place the BT anchors with 40′ spacing in the office; (4) create a zone for each BT anchor for testing. Preferably, the setup is used for testing the system from badge to Norada single pane of glass. This step is mandatory before you can configure and test the Location/panic badges. Then, verify the Connection from Actility Enterprise is being received by Norada.

To stage Norada, preferably perform the following: (1) Inventory the number of BT anchors for the project; (2) Place the BT anchors to the assigned spots on the blueprints using a graphical application like MS Visio or MS paint; and (3) Document the BT anchors and the blueprint location for installation in the Install Package.

To stage the Abeeway Device Manager, preferably perform the following: (1) Verify that the Connection from Actility Enterprise is being received by Abeeway Device Manager Web Site; (2) Verify all badges have reported to the ADM; (3) Verify the target badges are turned on; (4) Select the proper device template in ADM; and (5) Push the template to the Location/panic badge.

Then, using the Norada website, preferably perform the following: (1) Add the Location/panic badge as a user device; (2) Configure the profile with a name, Icon, SOS, and other operational perimeters; (3) Test the Location/panic badge for proper operation; and (4) Repeat for each location badge in the system.

Then, preferably connect the AlwaysOnAlerts radios' USB connection to the test laptop, by performing the following: (1) Program the radio to a test channel for staging; and (2) Verify that Emergency voice alerts are transmitted over the radio. Subsequently, verify that the customers set for connectivity in the installation, set an Acceptance Test Program for customer acceptance, and ship equipment for installation.

Finally, install and test the equipment, preferably performing the following steps: (1) Field Service to reprogram voice radio Base Station to match the customers radio network; (2) Field Service to install voice radio Base Station within the coverage area of the customers radio network; (3) Field Service to install the anchors in the customer facility as per the Bluetooth anchor drawing; (4) Install the LoRa gateways to the locations shown on the blueprint drawings; (5) Verify the Gateways are communicating with the Actility backend system (release the 360solve site to the customer for APT); (6) Supply customer training on use and charging of the Location/panic badges; and (7) Supply customer training on the use of the 360solve/Norada site.

As described herein, the above components and setup/operation software and firmware may vary depending on the desired vendors and equipment to be used in connection with the indoor tracking system and method. Accordingly, the aforementioned setup and verification process is exemplary and other methodologies may be utilized within the scope of the present invention.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. Further, any specific numbers noted herein are only examples: alternative implementations may employ differing values, measurements or ranges.

Although the operations of any method(s) disclosed or described herein either explicitly or implicitly are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

The teachings of the disclosure provided herein can be applied to other systems, not necessarily the system described above. The elements and acts of the various embodiments described above can be combined to provide further embodiments. Any measurements or dimensions described or used herein are merely exemplary and not a limitation on the present invention. Other measurements or dimensions are within the scope of the invention.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, ¶6 will include the words “means for”). Accordingly, the applicant reserves the right to add additional claims after filing the application to pursue such additional claim forms for other aspects of the disclosure.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A method of tracking within a structure that includes a plurality of rooms including at least first and second rooms, the method comprising the steps of:
providing at least first and second beacons, wherein the first beacon is disposed in the first room and the second beacon is disposed in the second room, wherein the first beacon transmits a first beacon identification signal that includes a first beacon identifier and the second beacon transmits a second beacon identification signal that includes a second beacon identifier,
providing at least a first tracking device that includes an activation member associated therewith, wherein the first tracking device is configured to receive the first beacon identification signal and the second beacon identification signal, wherein when the activation member on the first tracking device is activated the first tracking device is configured to determine whether the first beacon or second beacon is closer in proximity to the first tracking device, thereby determining a closest proximity beacon,
transmitting, by the first tracking device, the beacon identifier of the closest proximity beacon to a gateway,
transmitting, by the gateway, the beacon identifier of the closest proximity beacon to a cloud service that includes a positioning engine, wherein the positioning engine includes a map of the structure that associates the first beacon with the first room and the second beacon with the second room,
determining, by the positioning engine, a location of the closest proximity beacon,
transmitting, by the cloud service, the location of the closest proximity beacon to a computing system associated with the structure,
providing, by the computing system, an alert to at least a first transceiver that identifies the location of the closest proximity beacon, wherein the alert is at least one of an audio message, an audiovisual message or a visual message.

2. The method of claim 1 wherein the alert is an audio message.

3. The method of claim 2 wherein the audio message is routed through a base station and to a plurality of transceivers.

4. The method of claim 2 wherein the alert is provided via text to speech.

5. The method of claim 1 wherein the step of determining whether the first beacon or second beacon is closer in proximity to the first tracking device includes determining which of the first beacon identification signal or second beacon identification signal is stronger.

6. The method of claim 1 wherein the cloud service is located offsite from the structure.

7. The method of claim 1 wherein the first transceiver is a two-way radio.

8. The method of claim 1 wherein the gateway is a first gateway located on a first floor of the structure, wherein the structure includes a second floor with a second gateway.

9. The method of claim 1 wherein a first room activation member is located in the first room, wherein the first room activation member is configured to transmit a first room identification signal that includes a first room identifier, wherein when the first room activation member is pressed, the method includes the steps of transmitting to the computing system, by the first room activation member, the first room identifier, and providing to at least the first transceiver, by the computing system, a second alert that identifies the first room.

10. A method of tracking within a structure that includes a plurality of rooms including at least first and second rooms, the method comprising the steps of:
providing at least first and second beacons, wherein the first beacon is disposed in the first room and the second beacon is disposed in the second room, wherein the first beacon transmits a first beacon identification signal that includes a first beacon identifier and the second beacon transmits a second beacon identification signal that includes a second beacon identifier,
providing at least a first tracking device that includes an activation member associated therewith, wherein the first tracking device is configured to receive the first beacon identification signal and the second beacon identification signal, wherein when the activation member on the first tracking device is activated the first tracking device is configured to determine whether the first beacon or second beacon is closer in proximity to the first tracking device, thereby determining a closest proximity beacon,
transmitting to a gateway, by the first tracking device, the beacon identifier of the closest proximity beacon,
transmitting, by the gateway, the beacon identifier of the closest proximity beacon to a cloud service that includes a positioning engine, wherein the positioning engine includes a map of the structure that associates the first beacon with the first room and the second beacon with the second room,
determining, by the positioning engine, a location of the closest proximity beacon,
transmitting, by the cloud service, the location of the closest proximity beacon to a computing system associated with the structure,
providing to a base station, by the computing system, a text to speech audio message that identifies the closest proximity beacon,
routing, by the base station, the text to speech audio message that identifies the location of the closest proximity beacon to a plurality of transceivers.

11. The method of claim 10 wherein the first transceiver is a two-way radio.

12. The method of claim 11 wherein the step of determining whether the first beacon or second beacon is closer in proximity to the first tracking device includes determining which of the first beacon identification signal or second beacon identification signal is stronger.

13. An indoor tracking system for determining the location of at least a first tracking badge within a structure that includes a plurality of rooms, the indoor tracking system comprising:
a plurality of beacons each configured to transmit a beacon identification signal that includes a beacon identifier,
at least a first tracking device that includes an activation member associated therewith, wherein the first tracking device is configured to receive one or more of the beacon identifiers, wherein when the activation member is activated, the first tracking device is configured to determine the beacon of the plurality of beacons that is closest in proximity to the first tracking device, thereby determining a closest proximity beacon,
at least a first gateway configured to receive from the first tracking device the beacon identifier of the closest proximity beacon,
a positioning engine that includes location information comprising a location of each of the plurality of beacons, wherein the positioning engine is configured to identify a location of the closest proximity beacon,
a computing system, associated with the structure, configured to receive the location of the closest proximity beacon,
at least a first transceiver configured to receive and transmit an alert that identifies the location of the closest proximity beacon provided by the computing system.

14. The indoor tracking system of claim 13 wherein the positioning engine includes a map of the structure that associates each of the plurality of beacons with a different room within the structure.

15. The indoor tracking system of claim 13 wherein the positioning engine is part of an offsite cloud service.

16. The indoor tracking system of claim 13 wherein the alert is an audio message.

17. The indoor tracking system of claim 16 wherein the audio message is routed through a base station and to a plurality of transceivers.

18. The indoor tracking system of claim 16 wherein the alert is provided via text to speech.
